(19) United States
(12) Patent Application Publication
(10) Pub. No.: US 2006/0222243 A1
(43) Pub. Date: Oct. 5, 2006

(54) Extraction and scaled display of objects in an image

(76) Inventors: Martin E. Newell, San Jose, CA (US); Lubomir D. Bourdev, San Jose, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/097,951

(22) Filed: Apr. 2, 2005

(51) Int. Cl. G06K 9/34; G06K 9/46; G06K 9/32

(52) U.S. Cl. 382/173; 382/190; 382/298

(57) ABSTRACT

A method, system and apparatus perform detection and scaled display of objects in an image. In some embodiments, a method includes receiving an image that includes a face of a person. The method also includes extracting a part of the image that includes the face. The method includes scaling the part of the image that includes the face based on a size of a display. The method also includes displaying the part of the image that includes the face on the display.

### TECHNICAL FIELD

The application relates generally to data processing, and, more particularly, to processing of objects in an image.

### BACKGROUND

A number of different devices capture still and moving images. Examples of such devices include cameras (such as digital cameras), cellular telephones and Personal Digital Assistants (PDAs) having cameras, video recording devices, etc. Typically, after an image is captured, the image is reviewed to determine whether the objects therein are adequately captured. For example, if a digital camera is used to capture an image of a group of persons, the image may be reviewed to determine whether all of the persons were smiling, had their eyes open, looking into the camera, etc. Therefore, the faces of the persons are manually and individually enlarged for review. This process of panning, enlarging and reviewing can be problematic and time consuming.

### SUMMARY

According to some embodiments, a method, system and apparatus perform detection and scaled display of objects in an image. In some embodiments, a method includes receiving an image that includes a face of a person. The method also includes extracting a part of the image that includes the face. The method includes scaling the part of the image that includes the face based on a size of a display. The method also includes displaying the part of the image that includes the face on the display.

In some embodiments, a method includes receiving an image that includes a number of faces of persons. The method also includes detecting a face of the number of faces in the image. The method includes extracting a part of the image that includes the face. Additionally, the method includes scaling the part of the image based on a size of a display and based on a number of other parts of the image that include other faces that are extracted from the image for display. The method includes displaying the part of the image and the other parts of the image on the display.

In some embodiments, a method includes receiving an image that includes a number of objects of a same category. The method includes detecting a object of the number of objects in the image. The method also includes readjusting a layout of a display that is currently displaying other objects of the number of objects. The readjusting of the layout includes scaling the object and the other objects based on a size of the display and based on the number of other objects.

In some embodiments, a method includes performing the following operations each time an object is detected in an image. A first operation includes determining a size of a display. Another operation includes determining the number of other objects currently being displayed on the display. A different operation includes scaling the object and the other objects. Another operation includes readjusting a layout of the object and the other objects for display. Another operation includes displaying the readjusted layout on the display.

In some embodiments, a method includes receiving an image that includes a number of faces of persons. The method also includes detecting a current face of the number of faces in the image. The method includes discarding the current face if a response value of the current face is less than a low threshold or if boundaries of a different face that is within a set of potential faces for display on a display overlaps with boundaries of the current face and a response value of the different face is greater than the response value of the current face. Additionally, the method includes performing the following operations on a face within the set of potential faces if boundaries of the face overlap with boundaries of the current face and a response value of the face is less than the response value of the current face. An operation includes deleting the face within the set of potential faces for display. Another operation includes removing the face from the display if the response value of the face is greater than a high threshold.

In some embodiments, a method includes receiving an image that includes a face of a person. The method also includes extracting a part of the image that includes the face. The method includes scaling the part of the image that includes the face based on a size of a display. The method also includes displaying the part of the image that includes the face on the display.

In some embodiments, a method includes receiving an image that includes faces of persons. The method also includes detecting the faces of the persons. The method includes extracting, for each face detected, a part of the image that includes the face. Additionally, the method includes scaling the parts of the image that includes the faces based on a size of a display. The method includes displaying only one of the parts of the image at a time in an order that is a raster scan order of the faces in the image.

In some embodiments, an apparatus includes a display. The apparatus also includes means for capturing an image that includes a number of objects of a same category. The apparatus includes an image processor logic to receive the image. The image processor logic includes an object detection logic to detect an object of a number of objects in the image. The image processor logic includes a layout logic to scale the object based on a size of the display and to display the scaled object on the display.

In some embodiments, an apparatus includes means for receiving an image that includes a number of faces of persons. The apparatus also includes means for detecting a face of the number of faces in the image. The apparatus includes means for extracting a part of the image that includes the face. The apparatus also includes means for scaling the part of the image based on a size of a display and based on a number of other parts of the image that include other faces that are extracted from the image for display. The apparatus includes means for displaying the part of the image and the other parts of the image on the display.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates a system for detection and scaled display of objects in an image, according to some embodiments of the invention.

FIG. 2 illustrates a more detailed block diagram of an image processor logic for detection and scaled display of objects in an image, according to some embodiments of the invention.

FIG. 3 illustrates a flow diagram of operations for detection and scaled display of objects in an image, according to some embodiments of the invention.

FIG. 4 illustrates a flow diagram for removal operations for detected objects in an image, according to some embodiments of the invention.

FIG. 5 illustrates a flow diagram for an add operation for detected objects in an image, according to some embodiments of the invention.

FIG. 6 illustrates a flow diagram of operations for redrawing a layout of a display of objects in an image, according to some embodiments of the invention.

FIGS. 7A-7D illustrate a layout of objects extracted from an image over time, according to some embodiments of the invention.

FIGS. 8A-8D illustrate a layout on a display of objects extracted from an image over time, according to some other embodiments of the invention.

FIGS. 9A-9B illustrate a layout on a display of objects extracted from an image over time, according to some other embodiments of the invention.

FIG. 10 illustrates a layout on a display of objects extracted from an image relative to the positions of the objects in the image, according to some embodiments of the invention.

FIG. 11 illustrates a layout on a display of the image and the objects extracted from the image, according to some embodiments of the invention.

FIG. 12 illustrates a computer device that executes software for performing operations related to detection and scaled display of objects in an image, according to some embodiments of the invention.

### DETAILED DESCRIPTION

Methods, apparatus and systems for detection and scaled display of objects in an image are described. In the following description, numerous specific details are set forth. However, it is understood that embodiments of the invention may be practiced without these specific details. In other instances, well-known circuits, structures and techniques have not been shown in detail in order not to obscure the understanding of this description. Additionally, in this description, the phrase “exemplary embodiment” means that the embodiment being referred to serves as an example or illustration.

While described with reference to detection, scaling and displaying of faces of persons in an image, embodiments are not so limited as such operation may be used for any objects or components an image. Examples may include animals (such as dogs, cats, etc.), flowers, trees, different types of inanimate objects (such as automobiles, clothes, office equipment, etc.). Moreover, while described with reference to processing of an image, some embodiments may be used for frames within streams of video.

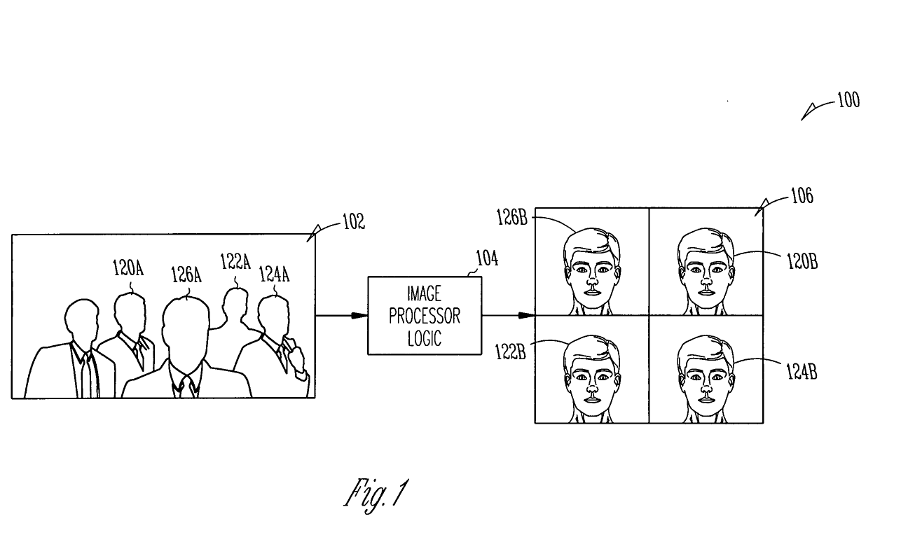

FIG. 1 illustrates a system for detection and scaled display of objects in an image, according to some embodiments of the invention. In particular, FIG. 1 illustrates a system 100 that includes an image 102, an image processor logic 104 and a display 106. The image processor logic 104 is coupled to receive the image 102. The image 102 may be a still image captured by a camera, a cellular telephone and a PDA having cameras, etc. In some embodiments, the image 102 may be a frame from a video stream. Therefore, the image 102 may be captured by different types of different video recording devices. In some embodiments, the image 102 includes a number of objects of a same category. As described above, the objects may be faces of persons or animals. The objects may be different objects in nature, such as flowers, trees, etc. The objects may also be different type of inanimate objects. In some embodiments, the image 102 may only include a single object.

As shown, the image 102 includes a person 120A, a person 122A, a person 124A and a person 126A. The image processor logic 104 is coupled to receive the image 102. For example, the image processor logic 104 may retrieve the image 102 from a memory (not shown). The image processor logic 104 processes the image to detect and extract the objects there from. The image processor logic 104 is also coupled to the display 106. The image processor logic 104 displays the objects that have been extracted onto the display 106. The display 106 includes a layout that displays a face 126B, which is the face of the person 126A. The layout also includes a face 120B, which is the face of the person 120A. The layout also includes a face 122B, which is the face of the person 122A. The layout includes a face 124B, which is the face of the person 124A.

As shown, the faces of the persons in the image 102 may be of varying size. In some embodiments, the image processor logic 104 layouts the objects such that the objects are as large as possible and are normalized. Therefore, some objects may be scaled up, and some objects may be scaled down. The layout of the objects is not limited to that shown in FIG. 1. Other examples of the different layouts are illustrated in FIGS. 7-11, which are described in more detail below. A more detailed description of the operations of the system 100 is set forth below.

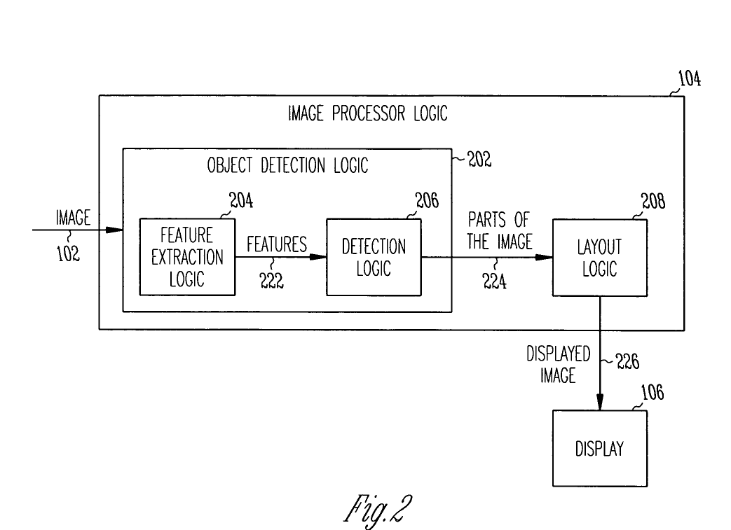

FIG. 2 illustrates a more detailed block diagram of an image processor logic for detection and scaled display of objects in an image, according to some embodiments of the invention. In particular, FIG. 2 illustrates a more detailed block diagram of the image processor logic 104, according to some embodiments of the invention.

The image processor logic 104 includes an object detection logic 202 and a layout logic 208. The object detection logic 202 includes a feature extraction logic 204 and a detection logic 206. The feature extraction logic 204 is coupled to receive the image 102. The feature extraction logic 204 may perform a dimensionality reduction of the image 102. The feature extraction logic 204 may also extract features from the image 102. Features may include different properties of the image 102 that are discriminating for the purpose of detecting faces therein. The features may include wavelet coefficients, edges, etc. The feature extraction logic 204 outputs the features 222 to the detection logic 206.

The detection logic 206 may detect the objects in the image 102 based on the features 222. In some embodiments, the detection logic 206 may extract features for a part of the image 102 to detect an object therein. The part of the image may be any size or shape window (e.g., a box, rectangle, etc.). The detection logic 206 may perform this detection based on any of a number of different types of operations. Such operations may include skin tone analysis, edge detection, etc. In some embodiments, the detection logic 206 may be trained by processing images that include different types of faces, images that are absent of faces, etc. In some embodiments, the detection logic 206 may be trained based on different learning algorithms, including but not limited to including boosting approaches, neural network-based approaches, support vector machines, etc. In some embodiments, the detection logic 206 may detect based on hardcoded data for faces. For example, the detection logic 206 may locate ovals in the image with two small circular darker areas where the eyes are to be positioned, etc. Examples of face detection, according to some embodiments, is described in the pending U.S. patent application Ser. No. ______, titled “Detecting Objects in Images using a Soft Cascade”, filed on Jan. 24, 2005, which is hereby incorporated by reference.

The detection logic 206 may output parts of the image 222 that includes the detected objects. The layout logic 208 may determine the layout of the display 106. The layout logic 208 may output a displayed image 226 based on the layout to the display 106.

Operations for detection and scaled display of objects in an image, according to some embodiments, are now described. In some embodiments, the operations may be performed by instructions residing on machine-readable media (e.g., software), by hardware, firmware, or a combination thereof. This description also includes screenshots of different layouts of the objects in the image onto a display, according to some embodiments of the invention. The screenshots help to illustrate the operations and are interspersed within the description of the flow diagrams. In particular, FIGS. 3-6 illustrate flow diagrams of operations for detection and scaled display of objects in an image, according to some embodiments of the invention. FIGS. 7-11 illustrate different layouts of the objects of in the image on a display, according to some embodiments of the invention.

FIG. 3 illustrates a flow diagram of operations for detection and scaled display of objects in an image, according to some embodiments of the invention. The flow diagram 300 is described with reference to the components of FIGS. 1 and 2. The flow diagram 300 commences at block 302.

At block 301, the image processor logic 104 receives an image that includes a number of faces of persons. With reference to FIGS. 1 and 2, the objection detection logic 202 may receive the image 102. As described above, the image 102 includes a number of faces of different persons. The feature extraction logic 204 (within the object detection logic 202) may perform a dimensionality reduction. As described above, the feature extraction logic 204 may extract features from the image 102. The feature extraction logic 204 outputs the features 222 to the detection logic 206. The flow continues at block 302.

At block 302, the detection logic 206 determines whether more faces are to be found in the image. In particular, the detection logic 206 may perform detection by processing features 222 in a given part (such as a box or rectangle) of the image 102. The detection logic 206 may process parts of the image 102 by commencing from the top, left hand corner of the image 102 and traversing the image 102 in a raster scan order. Therefore, the detection logic 206 may determine whether the processing is complete based on whether the part of the image in the bottom, right hand corner of the image 102 has been processed. Upon determining that there are no more faces to be found in the image, the flow continues at block 314, which is described in more detail below.

At block 304, upon determining that there are more faces to be found in the image, the detection logic 206 detects a current face in the image. As described above, in some embodiments, the detection logic 206 may extract features for a box or rectangle in the image 102 to detect a face therein. The detection logic 206 may perform this detection based on any of a number of different types of operations. The flow continues at block 305.

At block 305, the detection logic 206 extracts the part of the image that includes the current face. For example, the detection logic 206 may extract a box or rectangle that surrounds the current face. The flow continues at block 306.

At block 306, the detection logic 206 determines whether the response value for the current face is less than a low threshold. In some embodiments, the response value may be a continuous value that the detection logic 206 outputs as a confidence of whether the currently evaluated part of the image that includes the object (e.g., a face) superscribes an instance of the object. The response value may be an output of a neural network, the weighted sum of weak features for a boosted classifier, the sum of log likelihood ratio for a Bayesian-based classifier, etc.

As further described below, in some embodiments, multiple thresholds are used to determine whether a face is to be displayed. In some embodiments, a low threshold and a high threshold are used. If the response value for the current face is above the high threshold, the current face is displayed. If the response value for the current face is above the low threshold, the current face may potentially be displayed based on further processing (as described below). In some embodiments, these thresholds may be configurable by a user. For example, if the logic herein is part of a camera phone, the user may adjust these thresholds higher or lower to include less or more faces, respectively. The detection logic 206 may perform further processing of the current face to make the determination (as described below). Upon determining that the response value of the current face is below the low threshold, the current face is not displayed and flow continues at block 302.

At block 308, upon determining that the response value of the current face is above the low threshold, the detection logic 206 determines whether there is a face in a set of potential faces (for display), whose bounds overlap the current face and whose response value is greater than the response value of the current face. In particular, the set of potential faces (for display) include those faces that have been detected and that have a response value that is above the low threshold. The detection logic 206 may store this set of potential faces in memory (not shown in FIG. 2) to retrieve for this operation. The bounds of a face are the boundaries of the part of the image that is extracted there from that includes the face. In particular, the detection logic 206 may extract from the image a rectangle or box having the face. Therefore, the detection logic 206 compares the boundaries for each face in the set of potential faces to the boundaries of the current face to determine overlap there between. There may be various levels of overlap. In some embodiments, there needs to be significant overlap. For example, there is overlap between a first part and a second part of an image, if a center of the first part is within the second part, and if a center of the second part is within the first part. In some embodiments, there is overlap, if the centers of the first part and the second part are closer than some specified fraction of the size of the larger of the two parts in each dimension. If there is overlap for any of the potential faces and the current face, the detection logic 206 compares the respective response values.

Upon determining that any of the response values for the overlapping potential faces is greater than the response value of the current face, the flow continues at block 302. In other words, a better match has already been detected and is within the set of potential faces. Therefore, because there is a better match, the current face may be discarded. Upon determining that none of the response values for any overlapping potential faces is greater than the response value of the current face, the flow continues at block 310. In other words, a better match has not yet been detected.

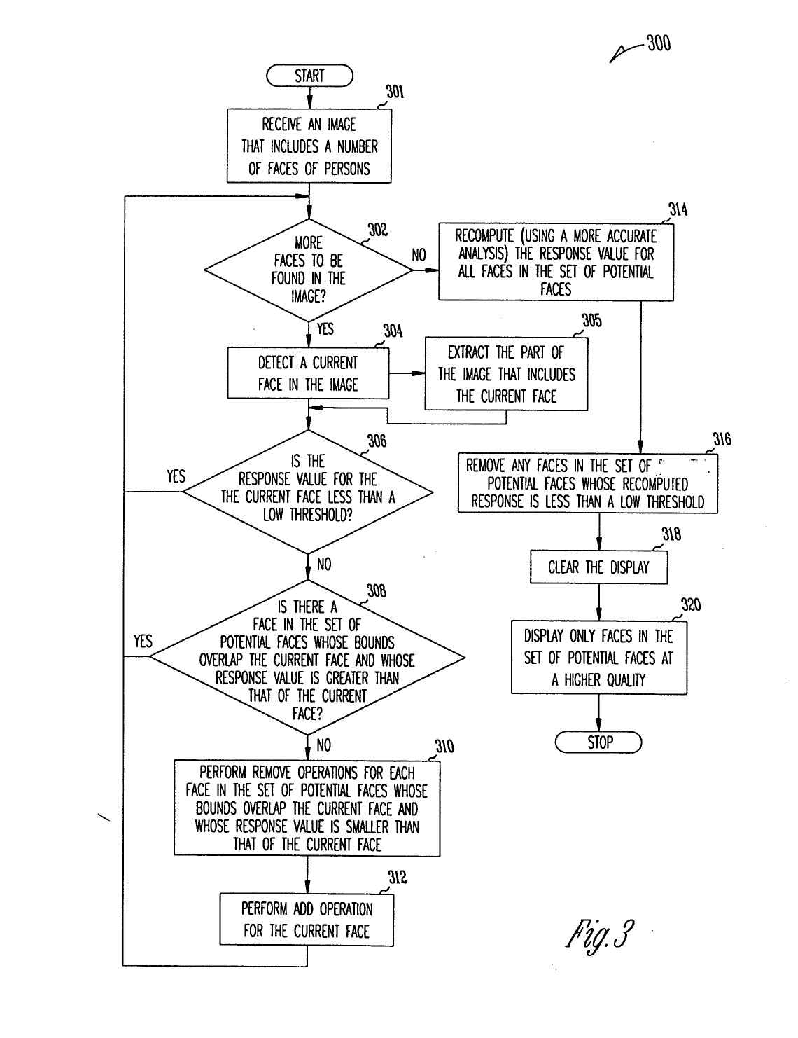

At block 310, the detection logic 206 performs remove operations for each face in the set of potential faces, whose bounds overlap the current face and whose response value is smaller than the response value of the current face. In other words, a better match has been found in comparison to these particular faces in the set of potential faces. Therefore, these particular faces may be removed. A more detailed description of these remove operations is set forth below in conjunction with FIG. 4. The flow continues at block 312.

At block 312, the detection logic 206 performs an add operation for the current face. In particular, the current face is added to the set of potential faces that are eligible for display. A more detailed description of this add operation is set forth below in conjunction with FIG. 5. The flow continues at block 302.

At block 314, the layout logic 208 recomputes (using a more accurate analysis) the response value for all faces in the set of potential faces. In some embodiments, a more accurate analysis may include any additional heuristic that may further confirm or discourage the candidate window (the part of the image being processed) from being classified as being a face. In some embodiments, a face localizer is used. A face localizer operation may include performing a local search near the hit for a face across position, scale and/or orientation. Such a local search may locate another close point where the response value is higher. In some embodiments, true faces have such peaks, while non-faces do not have such peaks. Therefore, the face localizer operation may increase the separation between the face and non-face responses. Other heuristics may be used for the more accurate analysis. For example, a skin tone analyzer operation may be used. The flow continues at block 316.

At block 316, the detection logic 206 removes any faces in the set of potential faces whose recomputed response value is less than the low threshold. The recomputed response values may be adjusted up or down based on the more accurate analysis. If this updated response value for a face is now less than the low threshold, the face does not have the potential for display and is discarded. The flow continues at block 318.

At block 318, the layout logic 208 clears the display. With reference to FIG. 2, the layout logic 208 may control the display 106 to cause the display 106 to clear the contents thereon. The flow continues at block 320.

At block 320, the layout logic 208 displays only those faces in a set of potential faces that are at a higher quality. In some embodiments, the layout logic 208 may not display all detected faces. In some embodiments, the layout logic 208 displays those faces in the set of potential faces that have a response value that is greater than the high threshold. The operations are complete.

In some embodiments, the operations of the flow diagram 300 may be performed for multiple scales and/or multiple orientations of the image. Therefore, after completing the scanning of the image for faces at a one scale or orientation, the detection logic 206 may rescan at a different scale or orientation.

FIG. 4 illustrates a flow diagram for removal operations for detected objects in an image, according to some embodiments of the invention. In particular, the flow diagram 420 illustrates more detailed operations of the removal operations at block 310 of FIG. 3. The flow diagram 420 is described with reference to the components of FIGS. 1 and 2. The flow diagram 420 commences at block 422.

At block 422, the detection logic 206 removes the to-be-removed face from the set of potential faces. In particular, the set of potential faces may be stored in memory (not shown in FIG. 2). Therefore, the detection logic 206 may update the set to remove the to-be-removed face from the set. The flow continues at block 424.

At block 424, the detection logic 206 determines whether the response value of the to-be-removed face is higher than a high threshold. As described above, multiple thresholds may be used. In some embodiments, a face is only displayed if its response value is greater than the high threshold. Upon determining that the response value of the to-be-removed face is not higher than the high threshold, the operations of the flow diagram 420 are complete.

At block 428, upon determining that the response value of the to-be-removed face is higher than the high threshold, the layout logic 208 removes the to-be-removed face from the display. The operations of the flow diagram 420 are then complete.

FIG. 5 illustrates a flow diagram for an add operation for detected objects in an image, according to some embodiments of the invention. In particular, the flow diagram 530 illustrates more detailed operations of the add operation at block 312 of FIG. 3. The flow diagram 530 is described with reference to the components of FIGS. 1 and 2. The flow diagram 530 commences at block 532.

At block 532, the detection logic 206 adds the to-be-added face to the set of potential faces. In particular, the set of potential faces may be stored in memory (not shown in FIG. 2). Therefore, the detection may update the set to include the to-be-added face to the set (which may be stored in memory (not shown in FIG. 2)). The flow continues at block 534.

At block 534, the detection logic 534 determines whether the response value for the to-be-added face is greater than the high threshold. Upon determining the response value for the to-be-added face is not greater than the high threshold, the operations of the flow diagram 530 are complete.

At block 538, upon determining that the response value of the to-be-added face is greater than the high threshold, the layout logic 208 adds the to-be-added face to the display. In some embodiments, the layout logic 208 replaces a face (a removal followed by an addition) because a better match was detected. In some embodiments, if the total number of faces to be displayed changes, the layout logic 208 may recompute the sizes and positions of the faces and redraws such faces accordingly. A more detailed description of this recomputation and redrawing is set forth below. The operations of the flow diagram 530 are then complete.

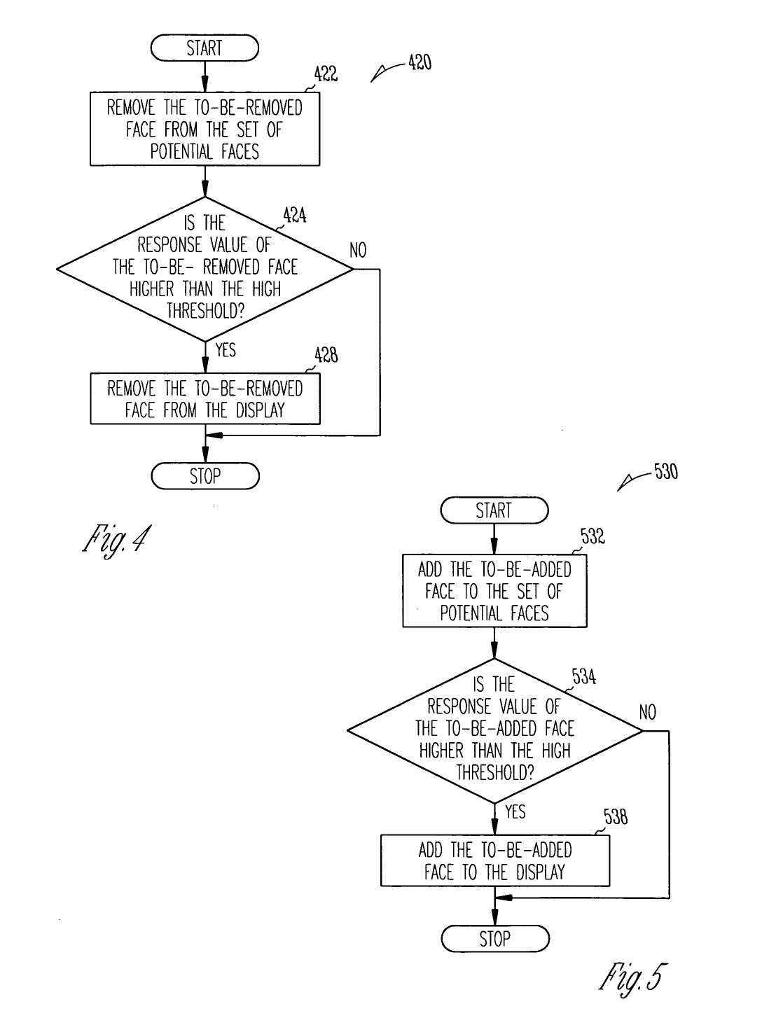

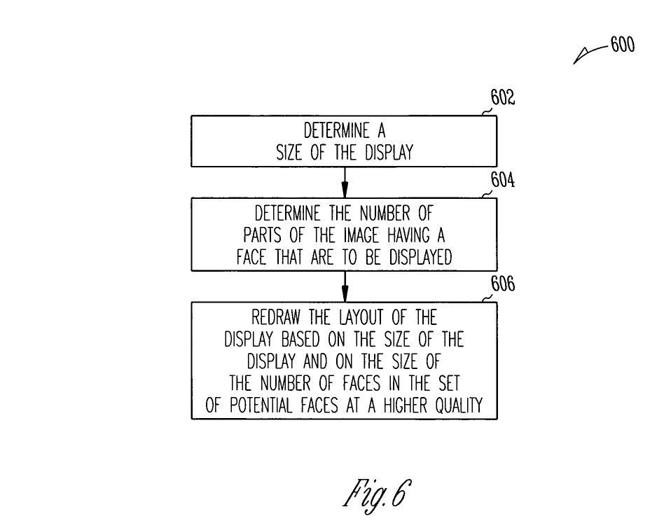

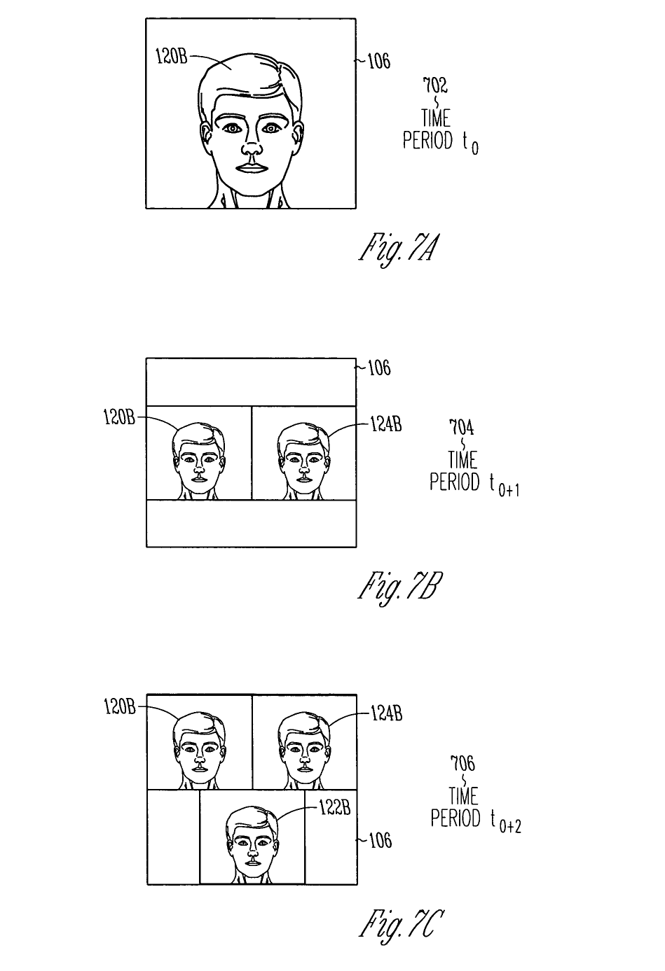

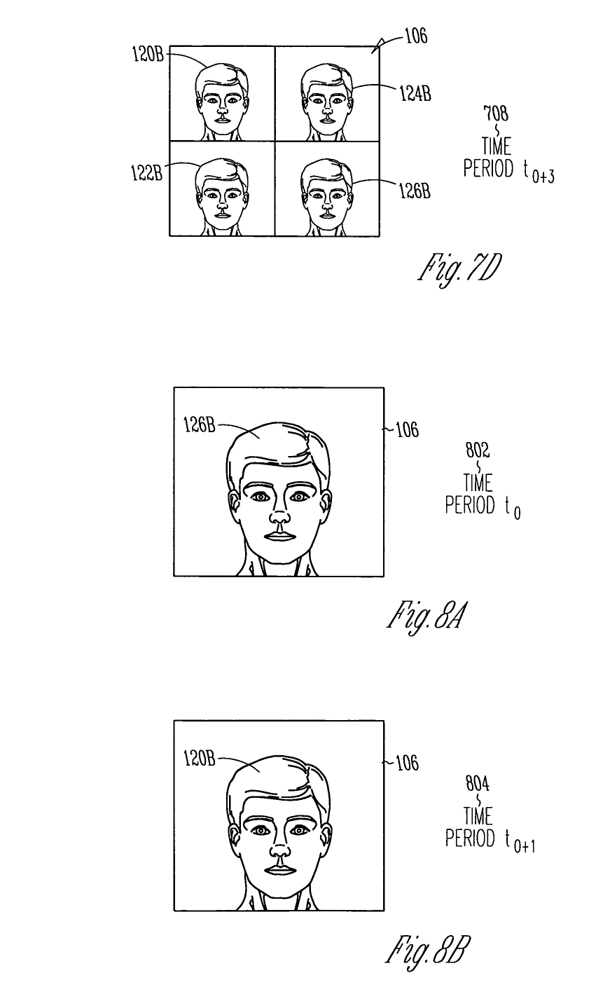

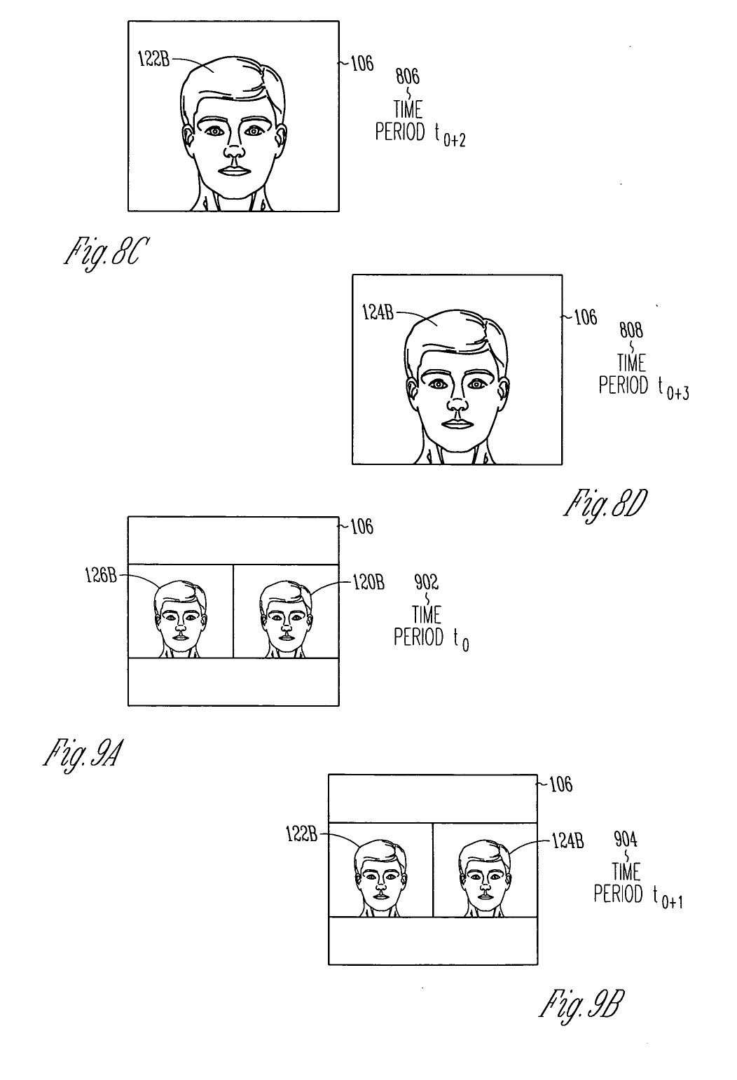

FIG. 6 illustrates a flow diagram of operations for redrawing a layout of a display of objects in an image, according to some embodiments of the invention. For example, the flow diagram 600 illustrates more detailed operations of redrawing the layout of the display after a new object is added or removed from the display. The flow diagram 600 is described with reference to the components of FIGS. 1 and 2. The flow diagram 600 commences at block 602.

At block 602, the layout logic 208 determines a size of the display. The layout logic 208 may determine the size of the display 106 in terms of number of pixels, blocks of pixels, etc. The flow continues at block 604.

At block 604, the layout logic 208 determines the number of parts of the image having a face that are to be displayed. In particular, the layout logic 208 may receive the parts of the image 224 (shown in FIG. 2). As described above, in some embodiments, only certain detected faces are displayed. In particular, only the detected faces whose response value is greater than a high threshold are displayed. The flow continues at block 606.

At block 606, the layout logic 208 redraws the layout of the display based on the size of the display and the number of parts of the image that are to be displayed. The layout logic 208 may redraw the layout in any of a number of different ways. FIGS. 7-11 (which are described below) illustrate different examples of the possible layouts. The operations of the flow diagram 500 are then complete.

A number of different layouts on the display 106 of the objects extracted from the image 102 are now described. FIGS. 7-11 illustrate such layouts, according to some embodiments of the invention. FIGS. 7-11 are described with reference to the faces of the persons shown in FIG. 1.

FIGS. 7A-7D illustrate a layout of objects extracted from an image over time, according to some embodiments of the invention. In particular, FIGS. 7A-7D illustrates how the layout of the display 106 is modified over time as the object detection logic 202 detects additional objects.

FIG. 7A illustrates the layout of the display 106 at a time period to 702. As shown at the time period t₀ 702, only the face 120B has been detected and extracted from the image 102 for display. Therefore, the face 120B is scaled up to span the display 106. In some embodiments, the objects are scaled up to be as large as possible based on the size of the display and the number of objects being displayed.

FIG. 7B illustrates the layout of the display 106 at a time period t₀₊₁ 704. As shown at the time period t₀₊₁, 704, the face 120B and the face 124B have been detected and extracted from the image 102 for display. Therefore (as shown), the face 120B and the face 124B are scaled to span the display 106. In some embodiments, the faces are normalized. Therefore, the windows of the faces and the faces therein are scaled to be approximately the same size.

FIG. 7C illustrates the layout of the display 106 at a time period t₀₊₂ 706. As shown at the time period t₀₊₂ 706, the face 120B, the face 124B and the face 122B have been detected and extracted from the image 102 for display. Therefore (as shown), the face 120B, the face 124B and the face 122B are scaled to span the display 106.

FIG. 7D illustrates the layout of the display 106 at a time period t₀₊₃ 708. As shown at the time period t₀₊₃ 708, the face 120B, the face 124B, the face 122B and the face 126B have been detected and extracted from the image 102 for display. Therefore (as shown), the face 120B, the face 124B, the face 122B and the face 126B are scaled to span the display 106. Accordingly, this operation of recomputing and redrawing the layout on the display 106 as the number of faces to be displayed is updated.

FIGS. 8A-8D illustrate a layout on a display of objects extracted from an image over time, according to some other embodiments of the invention. In particular, FIGS. 8A-8D illustrate a layout on the display 106, wherein only one face is displayed at a time. Therefore, the faces being displayed may be scaled up more in comparison to the layouts of FIGS. 7A-7D. This configuration may be useful if the image includes a large number of individuals. In particular, if the image includes too many persons, the layout may not be able to scale up or zoom in on the faces.

In some embodiments, the display 106 is changed after a predetermined time period. In some embodiments, the display 106 is changed based on user input. For example, the apparatus including such logic may include a scroll wheel to allow the user to change the current face being displayed.

The object detection logic 206 may store a buffer of the faces to be displayed. The layout logic 208 may then cycle through the faces therein for displaying. As described above, the number of faces detected and extracted may change over time. Therefore, the size of the buffer may also change. In some embodiments, the order of the faces in the buffer corresponds to the order in the image 102. For example, the order of the faces in the buffer may be a raster scan order of the faces in the image 102 (top to bottom and left to right). In some embodiments, the order that the faces are detected and extracted does not correspond to the order for display. Therefore, the object detection logic 206 may need to rearrange the faces stored in the buffer.

FIG. 8A illustrates the layout of the display 106 that includes the face 126B at a time period t₀ 802. FIG. 8B illustrates the layout of the display 106 that includes the face 120B at a time period t₀₊₁ 804. FIG. 8C illustrates the layout of the display 106 that includes the face 122B at a time period t₀₊₂ 806. FIG. 8D illustrates the layout of the display 106 that includes the face 124B at a time period t₀₊₃ 808.

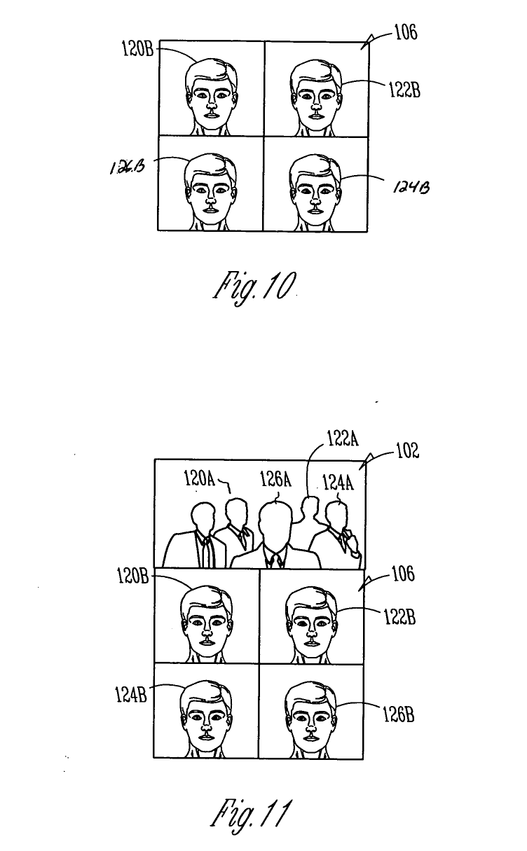

FIGS. 9A-9B illustrate a layout on a display of objects extracted from an image over time, according to some other embodiments of the invention. In particular, FIGS. 9A-9B illustrate a layout on the display 106, wherein two faces are displayed at a time. Therefore, FIGS. 9A-9B may be representative of a layout wherein more than one but less than all faces to be displayed are displayed. The faces being displayed may be scaled up more in comparison to the layouts of FIGS. 7A-7D.

FIG. 9A illustrates the layout of the display 106 that includes the face 126B and the face 120B at a time period to 902. FIG. 9B illustrates the layout of the display 106 that includes the face 122B and the face 124B at a time period t₀₊₁ 904. FIGS. 8 and 9 illustrate one face and two faces being displayed, respectively. Some embodiments may allow for a greater number of faces to be displayed at a given time.

FIG. 10 illustrates a layout on a display of objects extracted from an image relative to the positions of the objects in the image, according to some embodiments of the invention. As shown in FIG. 1, the position of the person 120A is the top left position of the image 102. Therefore, the face 120B is located in the top left position of the display 106. The position of the person 122A is the top right position of the image 102. Therefore, the face 122B is located in the top right position of the display 106. The position of the person 126A is the bottom left position of the image 102. Therefore, the face 126B is located in the bottom left position of the display 106. The position of the person 124A is the bottom right position of the image 102. Therefore, the face 124B is located in the bottom right position of the display 106.

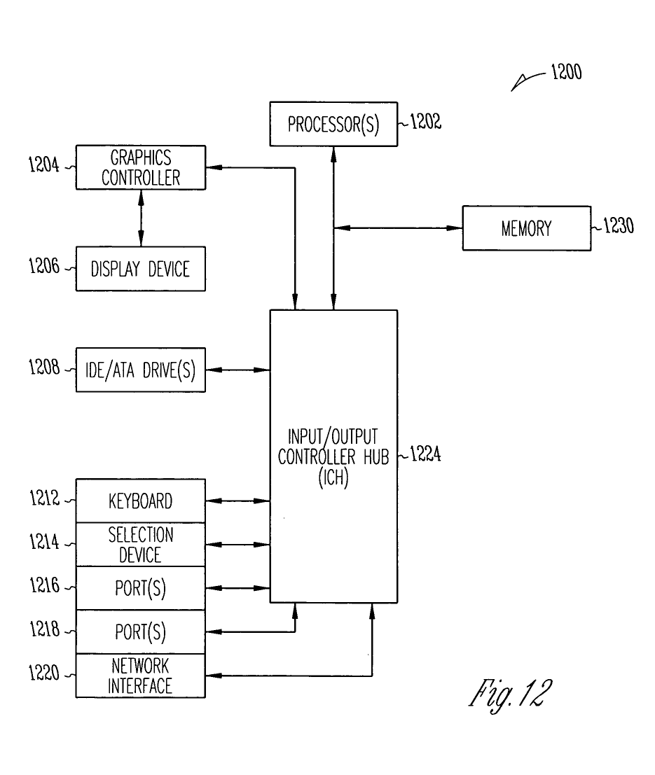

FIG. 11 illustrates a layout on a display of the image and the objects extracted from the image, according to some embodiments of the invention. FIG. 11 illustrates a layout that includes the image 102 as well as the faces detected and extracted there from for display (the face 120B, the face 122B, the face 124B and the face 126B). In some embodiments, the layout logic 208 highlights (e.g., place a box around) the persons whose faces have been detected and extracted for display. This may allow the user to manually zoom in on a face of a person that was not detected and extracted. In some embodiments, the user may adjust the thresholds (as described above) to include more or fewer faces for display.

Some embodiments wherein software performs operations related to detection and scaled display of objects in an image as described herein are now described. In particular, FIG. 12 illustrates a computer device that executes software for performing operations related to detection and scaled display of objects in an image, according to some embodiments of the invention. FIG. 12 illustrates a computer device 1200 that may be representative of any type of apparatus that is to receive an image for processing. For example, the computer device 1200 may be a camera, a camera telephone, a PDA, a video recording device, a desktop computer, a notebook computer, etc. Moreover, the computer device 1200 may have more or less components than those described below.

As illustrated in FIG. 12, a computer device 1200 comprises processor(s) 1202. The computer device 1200 also includes a memory 1230, a processor bus 1222, and an input/output controller hub (ICH) 1224. The processor(s) 1202, the memory 1230, and the ICH 1242 are coupled to the processor bus 1222. The processor(s) 1202 may comprise any suitable processor architecture. The computer device 1200 may comprise one, two, three, or more processors, any of which may execute a set of instructions in accordance with some embodiments of the invention.

The memory 1230 stores data and/or instructions, and may comprise any suitable memory, such as a random access memory (RAM). For example, the memory 1230 may be a Static RAM (SRAM), a Synchronous Dynamic RAM (SDRAM), DRAM, a double data rate (DDR) Synchronous Dynamic RAM (SDRAM), etc. A graphics controller 1204 controls the display of information on a display device 1206, according to an embodiment of the invention.

The ICH 1224 provides an interface to Input/Output (I/O) devices or peripheral components for the computer device 1200. The ICH 1224 may comprise any suitable interface controller to provide for any suitable communication link to the processor(s) 1202, the memory 1230 and/or to any suitable device or component in communication with the ICH 1224. For an embodiment of the invention, the ICH 1224 provides suitable arbitration and buffering for each interface.

In some embodiments, the ICH 1224 provides an interface to one or more suitable Integrated Drive Electronics (IDE)/Advanced Technology Attachment (ATA) drive(s) 1208, such as a hard disk drive (HDD). In an embodiment, the ICH 1224 also provides an interface to a keyboard 1212, a mouse 1214, one or more suitable devices through ports 1216-1218 (such as parallel ports, serial ports, Universal Serial Bus (USB), Firewire ports, etc.). In some embodiments, the ICH 1224 also provides a network interface 1220 though which the computer device 1200 may communicate with other computers and/or devices. In some embodiments, the ports 1216-1218 may be coupled to different types of devices to capture an image and/or video stream. Examples of such devices may include sensors, such as a Charge Coupled Device (CCD) sensor, a Complementary Metal Oxide Semiconductor (CMOS) sensor, etc.

With reference to FIGS. 1 and 2, the memory 1230 and/or one of the IDE/ATA drives 1208 may store the image processor logic 104, the object detection logic 202, the feature extraction logic 204, the detection logic 206 and the layout logic 208. In some embodiments, the image processor logic 104, the object detection logic 202, the feature extraction logic 204, the detection logic 206 and the layout logic 208 may be instructions executing within the processor(s) 1202. Therefore, the image processor logic 104, the object detection logic 202, the feature extraction logic 204, the detection logic 206 and the layout logic 208 may be stored in a machine-readable medium that are a set of instructions (e.g., software) embodying any one, or all, of the methodologies described herein. For example, the image processor logic 104, the object detection logic 202, the feature extraction logic 204, the detection logic 206 and the layout logic 208 may reside, completely or at least partially, within the memory 1230, the processor(s) 1202, one of the IDE/ATA drive(s) 1208, etc.

Embodiments may be used in any of a number of different applications. For example, some embodiments may be used when taking photographs of family or friends. Some embodiments may be used as part of a security application that includes face detection and recognition. For example, some embodiments may be used as part of an application for airport security to detect and recognize persons of interest. Some embodiments may be used in conjunction with capturing images of athletes in a sporting event. Moreover, some embodiments may be used in a video conferencing application. In particular, still frames may be captured from the video stream and then processed, according to some embodiments of the invention. In some embodiments, for this application, the face of the individual that is speaking is larger than the other faces, highlighted, etc. on the display.

In some embodiments, the input image may have been captured at a much earlier time (e.g., in terms of years). In some embodiments, the input image may have been capture by a different device than the one that includes the image processor logic 104. Therefore, the image processor logic 104 may receive the input image from a number of different sources including a machine-readable medium (such as a hard disk drive) on a same or different device and/or across a network. In some embodiments, the windows may be displayed on the display 106 in a number of different ways. For example, when adding a new object to the display 106, an animated transition may be made in which each existing object on the display 106 changes size and position smoothly over time. Further, the new object may grow from zero size into its allocated position over time.

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for detection and scaled display of objects in an image, in accordance with some embodiments of the invention. A number of flow diagrams illustrate the operations for detection and scaled display of objects in an image, in accordance with some embodiments of the invention. The operations of the flow diagrams are described with references to the systems/apparatus shown in the block diagrams. However, it should be understood that the operations of the flow diagrams may be performed by embodiments of systems and apparatus other than those discussed with reference to the block diagrams, and embodiments discussed with reference to the systems/apparatus could perform operations different than those discussed with reference to the flow diagrams.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

What is claimed is:

1. A method comprising:
receiving an image that includes a face of a person;
extracting a part of the image that includes the face;
scaling the part of the image that includes the face; and
displaying the part of the image that includes the face on a display.

2. The method of claim 1, wherein scaling the part of the image that includes the face includes scaling the part of the image based on a size of the display.

3. The method of claim 2, wherein scaling the part of the image that includes the face is based on a number of other parts of the image that include other faces that have been extracted.

4. The method of claim 3, wherein displaying the part of the image includes displaying the part of the image that includes the face and the other parts of the image that include other faces on the display at a same time.

5. The method of claim 4, wherein displaying the part of the image and the other parts of the image comprises displaying the parts of the image and the other parts of the image in positions that correspond to positions of the part of the image and the other parts of the image in the image.

6. The method of claim 3, further comprising scaling the other parts of the image that include the other faces, wherein the part of the image and the other parts of the image are approximately a same size.

7. The method of claim 6, wherein scaling the part of the image and the other parts of the image comprise scaling the part of the image and the other parts of the image, wherein the face and the other faces are approximately a same size. the face and the other faces.

8. A method comprising:
receiving an image that includes a number of faces of persons;
detecting a face of the number of faces in the image;
extracting a part of the image that includes the face;
scaling the part of the image based on a size of a display and based on a number of other parts of the image that include other faces that are extracted from the image for display; and
displaying the part of the image and the other parts of the image on the display.

9. The method of claim 8, wherein displaying the part of the image and the other parts of the image includes displaying the part of the image and the other parts of the image in positions that correspond to positions of the part of the image and the other parts of the image within the image.

10. The method of claim 8, wherein displaying the part of the image on the display includes displaying the part of the image and the other parts of the images, wherein a size of the part of the image and the other parts of the image are approximately equal.

11. The method of claim 8, wherein detecting the face of the number of faces in the image comprises detecting the face of the number of faces in the image based on a scan of the image at more than one scale.

12. A method comprising:
receiving an image that includes a number of objects of a same category;
detecting a object of the number of objects in the image;
readjusting a layout of a display that is currently displaying other objects of the number of objects, wherein the readjusting of the layout includes scaling the object and the other objects based on a size of the display and based on the number of other objects.

13. The method of claim 12, further comprising displaying the object and the other objects, which have been scaled, on the display.

14. The method of claim 12, wherein detecting the object of the number of objects in the image comprises detecting the object of the number of objects in the image based on a scan of the image at a number of scales.

15. A machine-readable medium that provides instructions which, when executed by a machine, cause said machine to perform operations comprising:
performing the following operations each time an object is detected in an image:
determining a size of a display;
determining the number of other objects currently being displayed on the display;
scaling the object and the other objects;
readjusting a layout of the object and the other objects for display; and
displaying the readjusted layout on the display.

16. The machine-readable medium of claim 15, wherein readjusting the layout of the object and the other objects comprises readjusting the layout, wherein the object and the other objects are displayed at a same time.

17. The machine-readable medium of claim 15, wherein displaying the readjusted layout of the display comprises displaying only one object at a time on the display.

18. The machine-readable medium of claim 15, wherein displaying the readjusted layout of the display comprises displaying more than one object, but less than all objects, at a time on the display.

19. A machine-readable medium that provides instructions which, when executed by a machine, cause said machine to perform operations comprising:
receiving an image that includes a number of faces of persons;
detecting a current face of the number of faces in the image;
discarding the current face if a response value of the current face is less than a low threshold or if boundaries of a different face that is within a set of potential faces for display on a display overlaps with boundaries of the current face and a response value of the different face is greater than the response value of the current face;
performing the following operations on a face within the set of potential faces if boundaries of the face overlap with boundaries of the current face and a response value of the face is less than the response value of the current face:
deleting the face within the set of potential faces for display; and
removing the face from the display if the response value of the face is greater than a high threshold.

20. The machine-readable medium of claim 19, further comprising displaying, on the display, faces having response values that are greater than the high threshold.

21. The machine-readable medium of claim 20, further comprising scaling the faces, having response values that are greater than the high threshold, based on the size of the display and the number of faces, having response values that are greater than the high threshold.

22. The machine-readable medium of claim 20, wherein displaying, on the display, the faces comprises displaying the faces on the display at the same time.

23. The machine-readable medium of claim 22, wherein displaying, on the display, the faces comprises displaying the faces in positions that correspond to positions of the faces in the image.

24. A machine-readable medium that provides instructions which, when executed by a machine, cause said machine to perform operations comprising:
receiving an image that includes faces of persons;
detecting the faces of the persons;
extracting, for each face detected, a part of the image that includes the face;
scaling the parts of the image that includes the faces based on a size of a display;
displaying only one of the parts of the image at a time in an order that is a raster scan order of the faces in the image.

25. The machine-readable medium of claim 24, wherein displaying only one of the parts of the image at a time comprises displaying a next part of the parts of the image in the order based on a user input.

26. The machine-readable medium of claim 24, wherein the user input comprises a scroll input.

27. The machine-readable medium of claim 24, wherein displaying only one of the parts of the image at a time comprises displaying only one of the parts of the image for a predetermined time period.

28. An apparatus comprising:
a display;
means for capturing an image that includes a number of objects of a same category;
an image processor logic to receive the image, wherein the image processor logic comprises:
an object detection logic to detect an object of a number of objects in the image; and
a layout logic to scale the object based on a size of the display and to display the scaled object on the display.

29. The apparatus of claim 28, wherein the layout logic is to scale the object based on the number of objects detected for display.

30. The apparatus claim 28, wherein the layout logic is to display objects detected for display at a same time.

31. The apparatus of claim 28, wherein the layout logic is to scale the objects detected for display, wherein the scaled objects are approximately a same size.

32. An apparatus comprising:
means for receiving an image that includes a number of faces of persons;
means for detecting a face of the number of faces in the image;
means for extracting a part of the image that includes the face;
means for scaling the part of the image based on a size of a display and based on a number of other parts of the image that include other faces that are extracted from the image for display; and
means for displaying the part of the image and the other parts of the image on the display.

33. The apparatus of claim 32, wherein means for displaying the part of the image and the other parts of the image includes means for displaying the part of the image and the other parts of the image in positions that correspond to positions of the part of the image and the other parts of the image within the image.

34. The apparatus of claim 32, wherein means for displaying the part of the image on the display includes means for displaying the part of the image and the other parts of the images, wherein a size of the part of the image and the other parts of the image are approximately equal.

35. The apparatus of claim 32, wherein means for detecting the face of the number of faces in the image comprises means for detecting the face of the number of faces in the image based on a scan of the image at more than one scale.
